(19) United States
(12) Patent Application Publication
(10) Pub. No.: US 2024/0026602 A1
(43) Pub. Date: Jan. 25, 2024

(54) Polyester Tufted Carpet And Polyester Nonwoven Carpet With Polyester Roll Coating

(71) Applicant: Auria Solutions UK I, Ltd., London (GB)

(72) Inventors: Ernest Franklin WILSON, Albemarle, NC (US); Timothy Joel Allison, Marion, NC (US); Sean Bracken Simmons, Concord, NC (US); Thomas STORCH, Großenlüder (DE)

(21) Appl. No.: 18/357,599

(22) Filed: Jul. 24, 2023

Related U.S. Application Data
(60) Provisional application No. 63/391,898, filed on Jul. 25, 2022.

(51) Int. Cl. D06N 3/12; D06N 3/00

(52) U.S. Cl. CPC D06N 3/123; D06N 3/0036; D06N 3/0086; D06N 2203/061; D06N 2209/16; D06N 2213/02; D06N 2213/063

(57) ABSTRACT

The present invention relates polyester tufted carpet where the tufts are engaged with a primary polyester backing and where a polyester roll coating is applied to the backside of the primary backing to lock the tufts which therefore avoids the use of a latex adhesive. The present invention also relates to the use of a polyester roll coating applied to the backside of a nonwoven polyester carpet.

### CROSS-REFERENCE TO RELATED APPLICATIONS

The present application claims the benefit of U.S. Provisional Application Ser. No. 63/391,898 filed Jul. 25, 2022, which is hereby incorporated by reference in its entirety.

### FIELD

The present invention relates polyester tufted carpet where the tufts are engaged with a primary polyester backing and where a polyester roll coating is applied to the backside of the primary backing to lock the tufts which therefore avoids the use of a latex adhesive. The present invention also relates to the use of a polyester roll coating applied to the backside of a nonwoven polyester carpet.

### BACKGROUND

Tufted fabrics, such as carpets and rugs, are generally made of numerous components and types of materials. Typically, in the tufting operation, yarn is inserted into a first or upper side of the primary backing material. The second or bottom side of the primary backing is then typically coated with a latex in order to adhere the yarn to the backing. Such latex may include a synthetic latex such as a styrene-butadiene latex composition. Carpets having such configuration can be relatively difficult to recycle and may often be disposed in landfill.

When considering the use of carpets in the automotive industry, OEMs typically establish standards for suppliers to achieve with respect to the physical property demands of the vehicle environment. Presently, OEM requirements have generally dictated that polyester tufted carpet utilize latex coatings to achieve the properties necessary for a given vehicle application. Accordingly, a need remains to develop a polyester tufted carpet, for vehicular applications, that would avoid the use of a latex coating, thereby reducing cost and improving recyclability at end of carpet life as well as the ability to more efficiently recycle the by-products of vehicle carpet manufacture.

### BRIEF DESCRIPTION OF FIGURES

FIG. 1 illustrates a tufted polyester with a primary backing passed over an applicator roller opposing a counter roller immersed in melt reservoir.

FIG. 2A is a perspective view of one example of a polyester tufted carpet having a polyester carpet layer, a primary polyester backing layer and a polyester roll coat.

FIG. 2B provides another perspective view of an example of polyester tufted carpet.

FIG. 3A illustrates the result of using a polyester roll coat as applied to the backside of a nonwoven carpet.

FIG. 3B illustrates the nonwoven polyester layer such as needled PET carpet the polyester roll coat as applied to the backside of a nonwoven carpet.

FIG. 4 provides a table showing the results of roll coating samples A-D.

### DETAILED DESCRIPTION

The present invention is directed at polyester tufted carpet where the tufts are engaged with a primary polyester backing and roll coating a polyester to the backside of the primary backing to lock the tufts. It also relates to roll coating of a polyester to the backside of a nonwoven polyester carpet. Such configuration therefore avoids the use of a latex adhesive coating. Such coating process can also be made continuous.

In a preferred method form, the present invention stands directed at a method for manufacturing a polyester carpet, comprising the steps of providing polyester yarn, providing a primary polyester backing and tufting the polyester yarn into the primary backing. This may then be followed melting a polyester and roll coating the melted polyester onto the back side of the primary backing to form a secondary polyester backing that locks the polyester tuffs in place. Such carpet construction is therefore formed entirely of polyester polymer.

In another preferred method form, the present invention stands directed at a method for manufacturing a polyester carpet, comprising the steps of providing a nonwoven polyester carpet, followed by melting a polyester and roll coating the melted polyester onto the back side of the nonwoven polyester carpet to form a polyester backing that also further locks the nonwoven polyester in place. Such carpet construction is therefore formed entirely of polyester polymer.

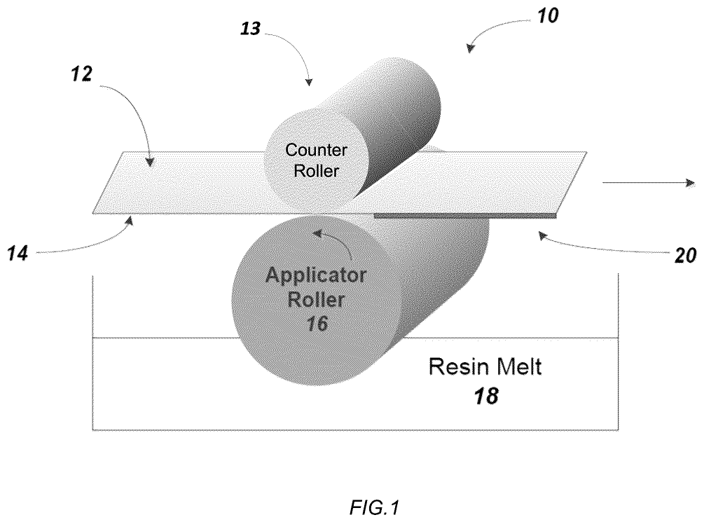

Reference to roll coating herein, for application to either polyester tufted carpet and/or nonwoven polyester carpet, may be understood as a molten coating process where at least one applicator roller is positioned in reservoirs of a hot melt. Upon rotation the applicator roller is coated with the molten polyester which then may be applied to the primary backing layer into which the polyester yarns is tufted or onto the backside of a nonwoven polyester. A perspective view of such roll coating operation 10 is provided in FIG. 1 for the exemplary case of a polyester tufted carpet with a primary backing. The characteristics of the polyester roll coating described below, are also contemplated to be suitable for application to the backside of a nonwoven polyester carpet.

As can be seen in FIG. 1, a tufted polyester 12 with a primary backing layer 14 on its underside is passed over an applicator roller 16 oppose a counter roller 13 that is immersed in a resin melt reservoir 18, which as noted, preferably is a molten PET or a blend of PET and coPET, as described further herein, with a Tm in the range of 100° C. to 280° C. The nip between the counter roller and application roller can be selectively adjusted to provide pressure to the tufted polyester passing in-between. After contact with the applicator roller a coating 20 of the polyester is then applied to the backside which then forms the secondary backing layer on the primary backing layer. The thickness of the coating so produced may preferably fall in the range of 5.0 microns to 500.0 microns, including all individual values and increments therein. The basis weight may range from 10.0 g/m² coating weight to 600.0 g/m² coating weight, including all individual values and ranges therein. The preferred viscosity of the PET coating material can fall in the range of 1500 cP to 100,000 cP, including all individual values and ranges therein. In such context a particularly preferred viscosity range is between 5000 cP to 30,000 cP including all individual values and increments therein.

Preferred application speeds for applying the polyester by roll coating to either the nonwoven polyester carpet or tufted polyester carpet can range from 1 meter/minute to 60 meters/minute, including all individual values and ranges therein. A particular preferred application speed therefore can fall in the range of 12 meters/minute to 20 meters/minute, including all individual values and increments therein. The preferred specific gravity of the polyester coating can range from 0.96 to 1.92 for relatively heavy modified or mineral filled polyester coating materials, including all individual values and increments therein. One example of a mineral filled polyester material is the addition of CaCO₃ to the polyester polymer. One preferred blend of 40% CaCO3/60% polyester combines the CaCO₃ specific gravity of 2.72 and the specific gravity of the polyester at 1.40 which then provides a compounded specific gravity of 1.93.

It should be appreciated in the above that one may also first coat the primary backing layer which has not yet been tufted with the polyester coating 20, and then provide polyester yarn and tuft into the primary backing layer and the secondary polyester backing layer.

The polyester yarn that is suitable for use herein in either polyester tufted carpet or polyester nonwoven carpet preferably comprises poly(ethylene terephthalate) (PET). The PET used to provide the tufted yarn may be virgin PET and/or PET obtained from recycled material, such as PET bottles, fabric or carpet waste. The level of recycled PET present may range from 0% (wt.) to 100% (wt.). Accordingly, the level of virgin PET that may be present ranges for 100% (wt.) to 0% (wt.). The PET yarn may preferably utilize fiber diameters range from 800 to 2400 denier, more preferably 900 to 1400 denier.

As noted, the primary backing layer in the polyester tufted carpet is also polyester based. Preferably, the primary backing is made only from PET and is a spunbond nonwoven. The spunbond filaments of such primary backing may also be compacted or bound using calendar treatment. It is also contemplated that the primary backing is a non-woven layer provided by melt-blowing, carding and/or needling. The primary layer may also include a woven layer of yarn, where the yarn is again, preferably made only from PET. The primary polyester backing herein may preferably have a basis weight of 80 g/m² to 160 g/m² at a thickness in the range of 0.25 mm to 1.0 mm.

The polyester that is utilized for the roll coating backing herein on either polyester tufted carpet or nonwoven polyester carpet is preferably PET and/or a copolymer of PET (coPET). That is, either PET on its own or a blend of PET with coPET. Reference to roll coating means that the subject resin is rolled directly onto the backside of the primary backing layer of the tufted polyester carpet or on the backside of the nonwoven polyester. Accordingly, one may preferably utilize 0-100% (wt.) PET and 100%-0% of coPET, including all individual values and increments therein. Reference to coPET is reference to the introduction of other diacids, such as isophthalic acid (IPA) and/or other diols, such as cyclohexane dimethanol (CHDM) to the PET. The coPET itself may therefore be preferably selected from one or more of poly(cyclohexylenedimethylene terephthalateglycol) (PCTG), poly(cyclohexylenedimethylene terephthalate/isophthalate glycol) (PCTA) and/or poly(cyclohexylenedimethylene terephthalate) (PCT).

For example, one may utilize a blend of PET and coPET on the back side of the primary backing where coPET is present a level of 1 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. %. Accordingly, the level of coPET may preferably be present in a blend with PET at a level of, e.g, 1 wt. % to 5 wt. %, 1 wt. % to 10 wt. %, 1 wt. % to 15 wt. %, 1 wt. % to 20 wt. %, 1 wt. % to 25 wt. %, 1 wt. % to 30 wt. %, 1 wt. % to 35 wt. %, 1 wt. % to 40 wt. %, 1 wt. % to 45 wt. %, 1 wt. % to 50 wt. %, 1 wt. % to 50 wt. %, 1 wt. % to 55 wt. %, 1 wt. % to 60 wt. %, 1 wt. % to 65 wt. %, 1 wt. % to 70 wt. %, 1 wt. % to 75 wt. %, 1 wt. % to 75 wt. %, 1 wt. % to 80 wt. %, 1 wt. % to 85 wt. %, 1 wt. % to 90 wt. %, 1 wt. % to 95 wt.

The polyester yarn, primary polyester layer and polyester backing layer may be formed together as follows. In one embodiment, the polyester yarn can be tufted into a first or upper side of the primary polyester backing layer. This then is followed by roll coating of polyester and formation of a polyester backing layer directly onto a second or bottom side of the primary backing layer. This serves to then bind and lock that yarn tufts. As may be appreciated, the roll coating of the polyester provides a relatively hot and malleable polyester melt that can then be readily applied to the primary backing and formed as a secondary backing layer.

Preferably, and as noted, the polyester roll coat that is applied to form the secondary backing layer is such that the polyester or polyester blend that is utilized herein for roll coating has a melting temperature in the range of 100° C. to 280° C., including all individual values and increments therein. More preferably, it has a melting temperature in the range of 120° C. to 240° C., more preferably in the range of 130° C. to 150° C. The polyester resin for roll coating may preferably be obtained from EMS Chemie Holding AG.

In addition, as noted, the polyester for roll coating can be a blend of PET and coPET such that the melt strength of such polyester blend is sufficient so that it can be readily applied during roll coating to form the secondary polyester backing noted herein. Such polyester backing may be on the backside of either polyester tufted carpet or nonwoven polyester carpet. Along such lines, it is contemplated herein that one may also utilize a branched PET, or even a relatively lightly crosslinked PET, wherein the branched or lightly crosslinked structure also improves the polymer-melt formability.

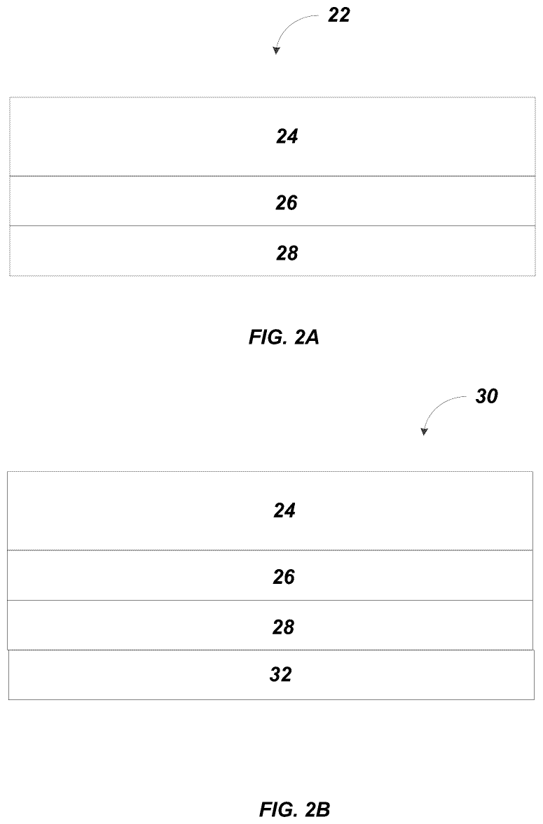

FIG. 2A provides a perspective view of one example of a polyester tufted carpet 22, having a tufted polyester carpet layer 24, a primary polyester backing layer 26 and a polyester roll coat 28. Reference to a polyester roll coat is reference to a polyester layer provided by roll coating as described herein. The polyester carpet layer 24, primary polyester backing layer 26 and polyester roll coat 28 are all preferably sourced from PET. FIG. 2B provides another perspective view of an example of a polyester tufted carpet 30 that again contains a tufted polyester carpet layer 24, a primary polyester backing layer 26 and a polyester roll coat 28, along with an optional acoustic fiber absorber layer 32. The acoustic fiber absorber layer 32 also preferably comprises polyester fiber and operates to absorb and effectively trap sound waves.

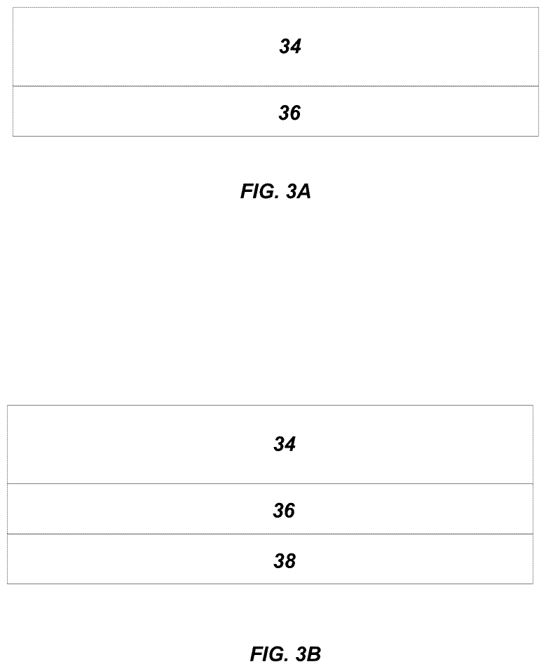

FIG. 3A illustrates the result of using a polyester roll coat as applied to the backside of a nonwoven carpet. Specifically, a nonwoven polyester, such as a needled PET carpet 34 now includes a polyester roll coating layer 36. FIG. 3B again illustrates the nonwoven polyester layer, such as a needled PET carpet 34, the polyester roll coating layer 36, and the optional use of acoustic fiber absorber layer 38.

It may therefore now be appreciated that via use of the polyester roll coating procedure, and the aforementioned selection of preferred polyester resins for such roll coating, one can provide a composite material (FIG. 2A, 2B, 3A or 3B) where one can tune or adjust the acoustical properties. For example, with regards to the polyester selected for roll coating, via selection of a preferred polyester viscosity (e.g., 1500 cP to 100,000 cp), polyester basis weight (10 g/m² to 600 g/m²), roll coating application pressure, it is contemplated that one can form a composite for carpeting that will have an air flow resistance in the range of 300 Rayls to 9000 Rayls, including all ranges and individual values therein. In addition, the polyester roll coating is contemplated to allow for the formation of either a porous or non-porous polyester layer 28 and 36, as illustrated in FIG. 2A, 2B, 3A or 3B.

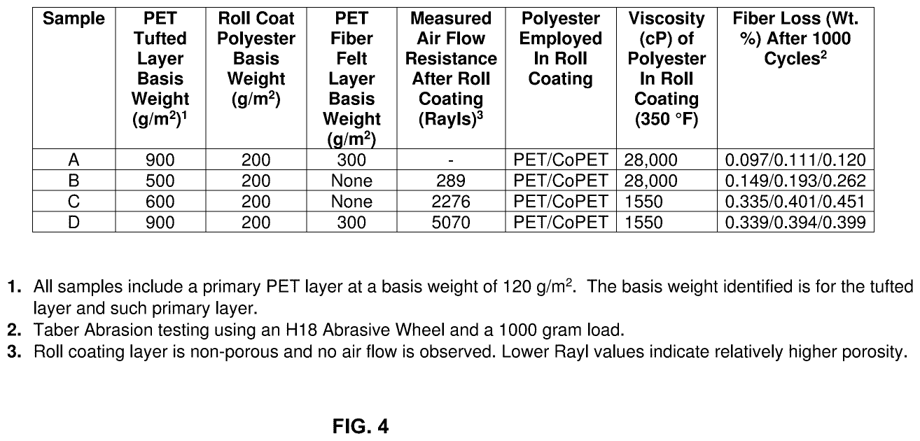

Attention is next directed to FIG. 4 which provides a table showing the results of roll coating on Samples A-D. Sample A represents polyester roll coating onto a PET tufted fiber with a primary polyester backing along with a PET fiber felt layer. Sample B represents polyester roll coating onto a PET tufted fiber with a primary polyester backing as does Sample C. Sample D is similar in general construction to Sample A, with the noted differences, e.g., in the viscosity of the polyester used for roll coating. As can be seen, the roll coating process allows one to prepare laminates with different air flow resistance and Taber Abrasion performance.

Accordingly, the present invention relates to a method for manufacturing a carpet, where the method comprises:
providing polyester yarn;
providing a primary polyester backing having first and second sides;
tufting the polyester yarn into a first side of said primary polyester backing where said yarn extends from said second side of said primary backing;
heating and melting a polyester and applying said melted polyester by roll coating the melted polyester to said second side of said primary backing wherein said polyester coating provides a secondary backing layer that engages said polyester yarn extending from said second side of said primary backing. The secondary polyester backing layer therefore serves to lock the polyester yarn in the polyester primary backing.

The present invention also relates to a related method for manufacturing a carpet, where the method comprises:
providing a primary polyester backing having first and second sides;
heating and melting a polyester and applying said melted polyester by roll coating to said second side of said primary backing and forming a secondary polyester backing layer;
providing polyester yarn and tufting the polyester yarn into said secondary polyester backing layer and into said primary backing layer.

The present invention also relates to a related method for manufacturing a carpet, where the method comprises:
providing a nonwoven polyester having first and second sides;
heating and melting a polyester and applying said melted polyester by roll coating to said second side of nonwoven polyester and forming a polyester backing layer.

In product form, the present invention relates to a tufted carpet, suitable for use in a vehicle, comprising, consisting essentially of, or consisting of polyester yarn engaged with primary polyester backing layer and a secondary backing layer of polyester applied by roll coating. Such may then be molded into a desired three-dimensional (3D) shape. In product form, the present invention also relates to a nonwoven polyester carpet that has a backing layer of polyester applied by roll coating.

The present invention therefore provides a carpet product that consists entirely of polyester and which eliminates the need to utilize a latex backing. The carpet so formed is contemplated to satisfy OEM requirements for vehicle carpeting such as Taber wear protocols. The carpet so formed is also more efficiently recycled given its unitary polyester composition. Along such lines it should be appreciated that the polyesters utilized herein, whether for the yarn, primary backing layer of secondary backing layer, may include non-polymeric components, such as non-polymeric filler materials and other related additives.

Various advantages are therefore contemplated from the present invention. Utilizing all polyester provide a more recyclable tufted carpet with the elimination of latex adhesives and the volatile organic compounds that are associated with the use of such latex. The above disclosure has therefore been made with reference to preferred embodiments and variations and modifications may be made within such scope by those of skill in the art.

1. A method for manufacturing a carpet, where the method comprises:
providing polyester yarn;
providing a primary polyester backing having first and second sides;
tufting the polyester yarn into a first side of said primary polyester backing where said yarn extends from said second side of said primary backing;
heating and melting a polyester and applying said melted polyester by roll coating the melted polyester to said second side of said primary backing wherein said polyester coating provides a secondary backing layer that engages said polyester yarn extending from said second side of said primary backing.

2. The method of claim 1 wherein said polyester applied by roll coating has a viscosity in the range of 1500 cp to 100,000 cp.

3. The method of claim 1 wherein said polyester applied by said roll coating has a thickness in the range of 5.0 microns to 500.0 microns.

4. The method of claim 1 wherein said polyester applied by said roll coating has a basis weight in the range of 10.0 g/m² to 600.0 g/m².

5. The method of claim 1 wherein said roll coating of said melted polyester is applied at a speed at an application speed of 1 meter/minute to 60 meters/minute.

6. The method of claim 1 wherein said polyester applied by roll coating provides a porous coating.

7. The method of claim 1 wherein said carpet has an airflow resistance in the range of 300 Rayls to 9000 Rayls.

8. The method of claim 1 wherein said melted polyester applied by roll coating is selected from the group consisting of poly(cyclohexylenedimethylene terephthalateglycol), poly(cyclohexylenedimethylene terephthalate/isophthalate glycol) and poly(cyclohexylenedimethylene terephthalate).

9. The method of claim 1 wherein said melted polyester applied by roll coating comprises a blend of branched PET and a copolymer of PET (coPET) having a melting temperature in the range of 100° C. to 280° C. and wherein said coPET is selected from the group consisting of poly(cyclohexylenedimethylene terephthalateglycol), poly(cyclohexylenedimethylene terephthalate/isophthalate glycol) and poly(cyclohexylenedimethylene terephthalate).
